(19) United States
(12) Patent Application Publication
(10) Pub. No.: US 2026/0102012 A1
(43) Pub. Date: Apr. 16, 2026

(54) WET AND SUPERHEATED STEAM COOKING APPLIANCE

(71) Applicant: Haier US Appliance Solutions, Inc., Wilmington, DE (US)

(72) Inventor: Byung Cheon Lee, Seoul (KR)

(21) Appl. No.: 18/916,791

(22) Filed: Oct. 16, 2024

(51) Int. Cl. A47J 27/04

(52) U.S. Cl. CPC A47J 27/04; A47J 2027/043

(57) ABSTRACT

A cooking appliance includes a base pan having a base wall and an internal wall forming a first and second volume. A wall opening permits fluid communication between the first and second volumes. A mid-pan is positioned on the base pan and is separated from the base pan by a base plate. A third volume is formed between the base plate and the mid-pan. A heater plate includes a top surface at which foodstuffs are received for heating and forms a fourth volume between the mid-pan and the heater plate. A shaft extends from the mid-pan and through the base plate. The shaft includes a passage extending in fluid communication from the third volume to above the heater plate. A shaft opening permits fluid communication from the passage to above the heater plate. A pan opening at the mid-pan permits fluid communication between the third and fourth volumes.

### FIELD OF THE INVENTION

The present subject matter relates generally to cooking appliances, and more particularly to steam cooking appliances.

### BACKGROUND OF THE INVENTION

Steamer cooking appliances (“steamers”) include structures for allowing steam generation and for steam to heat and cook food at the steamer. Steamers are generally constructed of materials appropriate for microwave use, such as plastic or glass. Consequently, such materials may be inappropriate or unusable for other heat sources, such as induction heaters or convection heating appliances. For instance, steamers may be inappropriate or unusable for stovetop heating elements, oven chamber cooking, or grills, or other cooking apparatuses.

Steamers generally provide water vapor to food for heating and cooking. However, applying water vapor to food can result in food becoming undesirably wet. Furthermore, over-application of steam may result in overcooking, loss of flavor or nutrients, or undesired food texture (e.g., softness, sponginess)

Accordingly, a steam cooking appliance that addresses one or more of the aforementioned issues would be advantageous and beneficial.

### BRIEF DESCRIPTION OF THE INVENTION

Aspects and advantages of the invention will be set forth in part in the following description, or may be obvious from the description, or may be learned through practice of the invention.

An aspect of the present disclosure is directed to a cooking appliance including a base pan including a base wall and an internal wall. The internal wall forms a first volume and a second volume at the base pan. The internal wall includes a wall opening permitting fluid communication between the first volume and the second volume. A mid-pan is positioned on the base pan. A base plate separates the mid-pan from the base pan. A third volume is formed between the base plate and the mid-pan. The third volume is fluidly connected to the second volume. A heater plate includes a top surface at which foodstuffs are received for heating. The heater plate is positioned on the mid-pan and forms a fourth volume between the mid-pan and the heater plate. A shaft extends from the mid-pan and through the base plate. The shaft includes a passage extending in fluid communication from the third volume to vertically above the heater plate. The shaft includes a shaft opening permitting fluid communication from the passage through the shaft to above the heater plate. The mid-pan includes a pan opening permitting fluid communication between the third volume and the fourth volume.

An aspect of the present disclosure is directed to a steam cooking appliance including a base pan including a base wall and an internal wall. The internal wall forms a first volume and a second volume at the base pan. The internal wall includes a wall opening permitting fluid communication between the first volume and the second volume. A mid-pan is positioned on the base pan. A base plate separates the mid-pan from the base pan. A third volume is formed between the base plate and the mid-pan. The third volume is fluidly connected to the second volume. A heater plate includes a top surface at which foodstuffs are received for heating. The heater plate is positioned on the mid-pan and forms a fourth volume between the mid-pan and the heater plate. A shaft extends from the mid-pan and through the base plate. The shaft includes a passage extending in fluid communication from the third volume to vertically above the heater plate. The shaft includes a shaft opening permitting fluid communication from the passage through the shaft to above the heater plate. The mid-pan includes a pan opening permitting fluid communication between the third volume and the fourth volume.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an embodiment of a steamer cooking appliance in accordance with aspects of the present disclosure;

FIG. 2 provides a cutaway perspective view of the steamer cooking appliance in accordance with aspects of the present disclosure;

FIG. 3 provides a cutaway perspective view of the steamer cooking appliance, depicting a first mode of operation, in accordance with aspects of the present disclosure;

FIG. 4 provides a cutaway perspective view of the steamer cooking appliance, depicting a second mode of operation, in accordance with aspects of the present disclosure;

FIG. 5 provides a perspective view of an embodiment of a base pan and plate in a first position of the steamer cooking appliance in accordance with aspects of the present disclosure; and

FIG. 6 provides a perspective view of an embodiment of a base pan and plate in a second position of the steamer cooking appliance in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

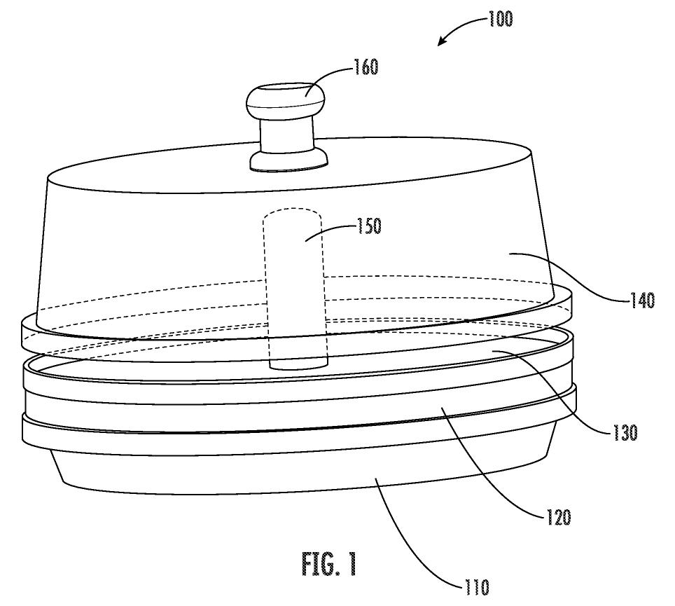

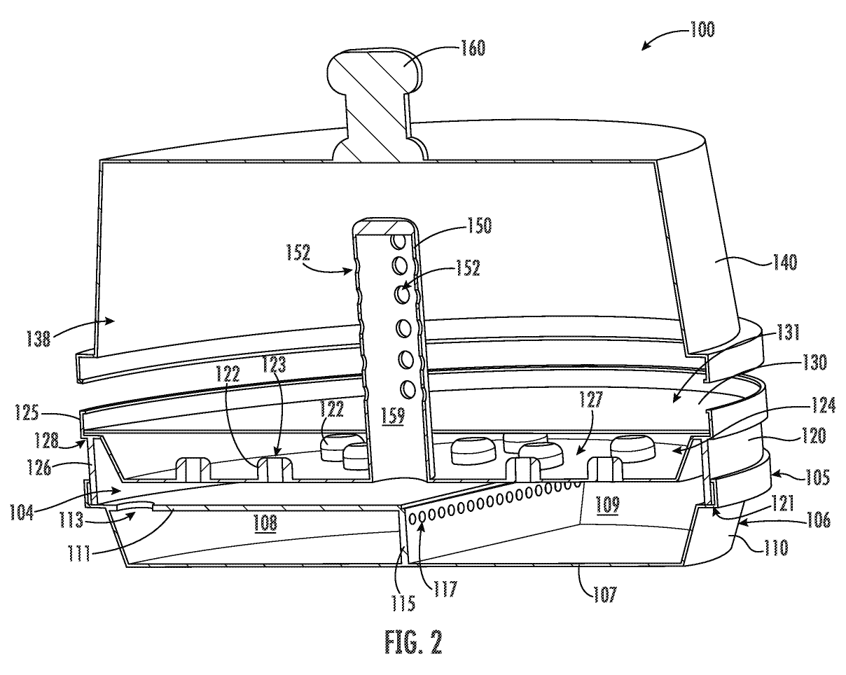

Referring now to the drawings, FIG. 1 provides a perspective view of a steamer cooking appliance 100 (hereinafter, “steamer 100”). FIG. 2 provides a cutaway perspective view of an embodiment of the steamer 100. Embodiments of the steamer 100 include a base pan 110, a mid-pan 120, and a heater plate 130. The heater plate 130 includes a top surface 131 at which food or foodstuffs are received to be heated or cooked. Plate 130 is positioned on mid-pan 120. Mid-pan 120 is positioned on base pan 110.

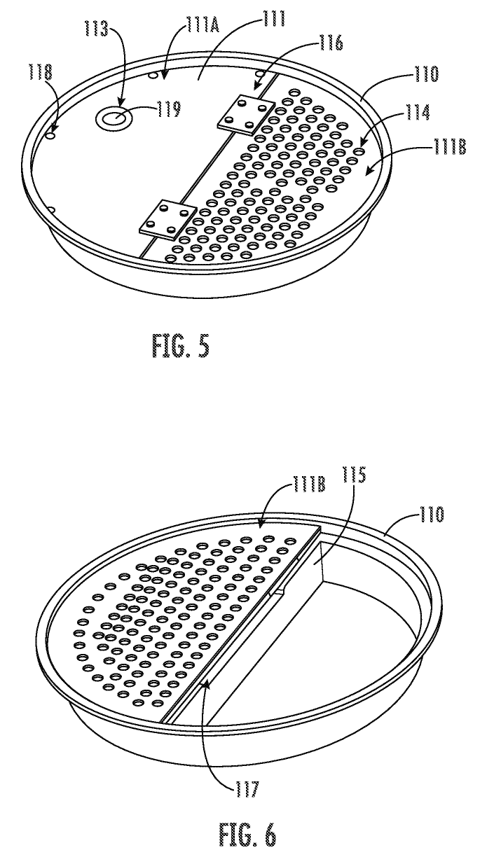

Base pan 110 includes a base wall 107 and a peripheral wall 106 extending from the base wall 107. An internal volume is formed between the base wall 107 and the peripheral wall 106. An internal wall 115 is positioned within the internal volume and extending from the base wall 107 and peripheral wall 106. The internal wall 115 forms two or more volumes 108, 109 between the base wall 107 and peripheral wall 106. Wall 115 includes a wall opening 117 extending through wall 115 to allow for fluid communication between volume 108 and volume 109, such as further described herein. In various embodiments, opening 117 is positioned at wall 115 to permit fluid communication of steam between volumes 108, 109 while allowing wall 115 to substantially inhibit fluid communication of water between volumes 108, 109. For instance, opening 117 may be positioned at an upper half or an upper quarter of the wall 115, such that rising water vapor or steam is permitted to pass through wall 115 while water remains at one or both of volumes 108, 109. In various embodiments, opening 117 may include a hole (e.g., depicted in FIG. 2), a slit, slot, or elongated opening (e.g., depicted in FIG. 6), or pluralities thereof.

A base plate 111 provides a surface separating one or more volumes 108, 109 from a pan base wall 127 of the mid-pan 120, such as to form a volume 104 between the base plate 111 and pan base wall 127. As such, base plate 111 may vertically separate volume 108 from volume 104. Referring briefly to FIG. 5, in some embodiments, base plate 111 may include a first base plate 111A providing an upper barrier to volume 108. In some embodiments, base plate 111 may include a second base plate 111B providing an upper barrier to volume 109 (FIG. 2), such as to vertically separate volume 109 from volume 104. Second base plate 111B may include a plate opening 114 configured to allow for fluid communication between volume 109 and volume 104, such as further described herein.

Referring to FIGS. 5-6, in some embodiments, base plate 111 may include a hinge 116 allowing first or second base plates 111A, 111B to fold onto one another. For instance, FIG. 5 depicts first and second base plates 111A, 111B in a first position in which first base plate 111A is positioned over first volume 108 (e.g., providing an upper barrier to volume 108), and second base plate 111B is positioned over second volume 109 (e.g., providing an upper barrier to volume 109). Base plates 111A, 111B provide a wall separating volumes 108, 109 from third volume 104 (FIG. 2). As further described herein, opening 114 permits fluid communication from volume 109 to volume 104.

Base plate 111 may include a cap opening 113 through which water may be received to volume 108. A cap 119 may be selectively positioned to open and close opening 113 to permit water to be added to volume 108. Cap 119 may seal fluid communication from volume 108 through opening 113, such as to inhibit fluid flow (e.g., steam flow) from volume 108 to volume 104 through opening 113.

In some embodiments, plate 111 is secured, sealed, or fastened to base pan 110. For instance, plate 111 is attached to base pan 110 to mitigate or inhibit fluid communication between volumes 104, 108, 109 except through openings 114, 117. Referring to FIG. 5, plate 111 and base pan 110 may include a fastener 118 coupling the first base plate 111A to the base pan 110. Hinge 116 permits the second base plate 111B to rotate onto the first base plate 111A, such as depicted in FIG. 6.

Referring back to FIG. 2, mid-pan 120 includes a mid-pan opening 123 configured to permit fluid communication from volumes 104, 109 to a fourth volume 124 formed between the mid-pan 120 and the heater plate 130. In some embodiments, opening 123 is positioned at a nozzle 122 extending into volume 124. Nozzle 122 may be configured to entrain and eject a flow of steam to heater plate 130.

Mid-pan 120 may include a peripheral wall 126 supporting the pan base wall 127 vertically over base plate 111. For instance, peripheral wall 126 may position base wall 127 vertically over base plate 111 to form volume 104 between base wall 127 and base plate 111. Peripheral wall 126 may dispose onto a lip 121 between peripheral wall 106 of base pan 110 and an outer peripheral wall 105 of base pan 110. Outer peripheral wall 105 is positioned radially outward of peripheral wall 106.

Mid-pan 120 may include an outer peripheral wall 125 positioned radially outward of peripheral wall 126. Heater plate 130 may dispose onto a lip 128 between peripheral wall 126 of mid-pan 120 and an outer peripheral wall 125 of mid-pan 120.

A steam shaft 150 extends vertically upward from pan base wall 127. Shaft 150 forms a flow passage 159 extending in fluid communication from volume 104. Shaft 150 includes an opening 152 permitting fluid communication from passage 159 to a fifth volume 138 over the heater plate 130. For instance, volume 138 is formed vertically over heater plate 130. Volume 138 may include an open air volume (e.g., external volume), or a volume between heater plate 130 and a surrounding cover or lid 140.

Lid 140 may include a handle 160 at which a user may utilize to selective move and position the lid 140 onto mid-pan 120 or heater plate 130. For instance, FIGS. 2-4 depict the lid 140 partially removed from mid-pan 120. Lid 140 extends vertically over shaft 150. For instance, opening 152 permits fluid flow from passage 159 into volume 138 under lid 140. Lid 140 may capture or inhibit release of steam and heat from volume 138, such as may promote heating and cooking of food at heater plate 130.

In various embodiments, steamer 100 is formed of materials appropriate for stovetop and oven heating elements (e.g., electric or gas heating elements), microwave oven appliances, and grills, including induction and convection heating devices. For instance, one or more of the base pan 110, mid-pan 120, heater plate 130, lid 140, or shaft 150 may be formed of metal or metallic structure. Base wall 107 may be configured to receive a direct or indirect heating source, such as induction heating, microwave, convection heating, etc.

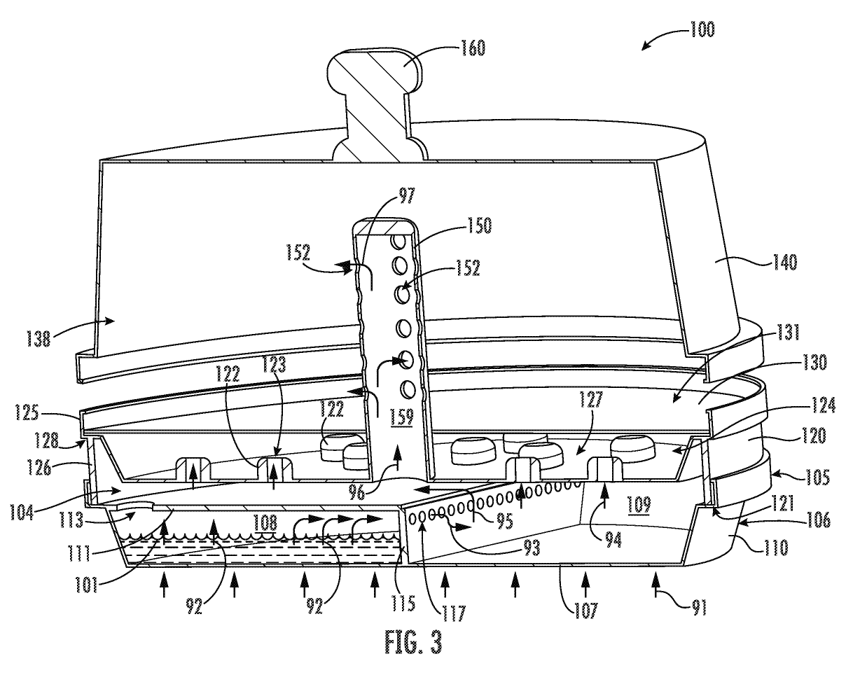

Referring now to FIG. 3, an exemplary embodiment of a first mode of operation is schematically depicted. The first mode of operation may generate superheated steam for heating and cooking. In the exemplary first mode of operation, water 101 is provided to volume 108. A heat source provides thermal energy, depicted schematically via arrows 91, to base wall 107. Thermal energy received at water 101 generates steam at volume 108, such as depicted schematically via arrows 92. Steam 92 may form dry steam heating base plate 111. Steam 92 is permitted to flow through opening 117 to volumes 104, 109, depicted schematically via arrows 93. Thermal energy 91 received through base wall 107 at volume 109 superheats the air and steam at volume 109. Steam may further propagate from volume 109 through volume 104, such as depicted schematically via arrows 95. Superheated steam 109 is permitted to flow through opening 123 to volume 124. The superheated steam may eject or impinge onto heater plate 130, providing thermal energy to the heater plate 130 to heat and cook food at top surface 131 of the heater plate 130. Superheated steam may further flow from volume 104 through passage 159, such as depicted schematically via arrows 96. Steam at passage 159 is permitted to egress from shaft 150 through opening 152 to volume 138, such as may provide steam onto food positioned at the top surface 131 of the heater plate 130.

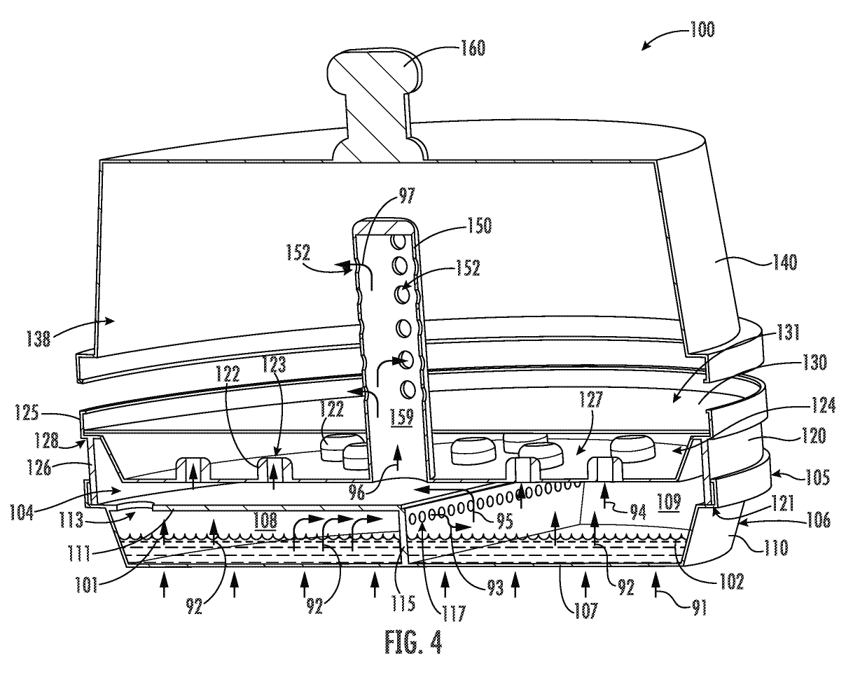

Referring now to FIG. 4, an exemplary embodiment of a second mode of operation is schematically depicted. The second mode of operation may generate wet steam for steam cooking, fermentation, proofing, warming, or other appropriate types of cooking and warming. In the exemplary second mode of operation, water 101 is provided to volume 108, and water 102 is provided to volume 109. A heat sources provides thermal energy to base wall 107, such as described herein. Thermal energy received at water 101, 102 generates steam (e.g., wet steam). Steam is permitted to flow through openings 123, 152 to passage 159 and volumes 124, 138 such as described herein.

Embodiments of the steamer 100 provided herein facilitate use of various heat sources (e.g., fire, electric, gas, induction, convection, conventional, etc.) to generate wet, dry, or superheated steam for heating or cooking food. Embodiments provided herein may overcome issues related to heat generation, food type, and heat source. Embodiments of the steamer 100 may provide desirable levels of moisture and dryness, healthier food preparation, desired textures, and improved heating.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a base pan comprising a base wall and an internal wall, wherein the internal wall forms a first volume and a second volume at the base pan, the internal wall comprising a wall opening permitting fluid communication between the first volume and the second volume;
a mid-pan positioned on the base pan;
a base plate separating the mid-pan from the base pan, wherein a third volume is formed between the base plate and the mid-pan, and wherein the third volume is fluidly connected to the second volume;
a heater plate comprising a top surface at which foodstuffs are received for heating, the heater plate positioned on the mid-pan and forming a fourth volume between the mid-pan and the heater plate; and
a shaft extending from the mid-pan and through the base plate, wherein the shaft comprises a passage extending in fluid communication from the third volume to vertically above the heater plate, wherein the shaft comprises a shaft opening permitting fluid communication from the passage through the shaft to above the heater plate,
wherein the mid-pan comprises a pan opening permitting fluid communication between the third volume and the fourth volume.

2. The cooking appliance of claim 1, comprising:
a lid disposable onto the mid-pan or heater plate, wherein the lid encloses a fifth volume formed between the lid and the heater plate.

3. The cooking appliance of claim 2, wherein the shaft extends vertically to permit fluid communication from the passage to the fifth volume.

4. The cooking appliance of claim 1, wherein the mid-pan comprises a nozzle at which the pan opening is positioned.

5. The cooking appliance of claim 4, wherein the nozzle extends vertically toward the heater plate to flow fluid from the third volume to the fourth volume.

6. The cooking appliance of claim 5, wherein the nozzle extends vertically toward the heater plate to impinge fluid onto the heater plate.

7. The cooking appliance of claim 1, wherein the base plate forms an upper barrier separating the first volume from the third volume.

8. The cooking appliance of claim 1, wherein the base plate comprises a first base plate providing an upper barrier separating the first volume from the third volume, and wherein the base plate comprises a second base plate providing an upper barrier separating the second volume from the third volume.

9. The cooking appliance of claim 8, wherein the second base plate comprises a plate opening permitting fluid communication between the second volume and the third volume.

10. The cooking appliance of claim 8, wherein the base plate comprises a hinge coupling the first base plate to the second base plate, wherein the hinge allows the first and second base plates to fold onto one another.

11. The cooking appliance of claim 8, wherein the first base plate comprises a cap opening providing fluid flow through the base plate to the first volume.

12. The cooking appliance of claim 11, wherein the base plate comprises a cap removably disposed at cap opening to selectively inhibit fluid flow through the cap opening.

13. The cooking appliance of claim 1, wherein the base plate is fastened to the base pan to inhibit fluid flow between the base plate and the base pan from the first volume.

14. The cooking appliance of claim 1, wherein the wall opening is positioned at an upper half of the internal wall to permit flow of water vapor between the first and second volumes and inhibit flow of liquid water between the first and second volumes.

15. The cooking appliance of claim 1, wherein the base pan comprises a metal or metallic material.

16. The cooking appliance of claim 1, wherein the base pan, the baes plate, the mid-pan, and the heater plate are positioned in vertical arrangement to one another.

17. The cooking appliance of claim 1, wherein the first volume and the second volume are configured to accept a volume of water at the respective first and second volumes.

18. A steam cooking appliance, comprising:
a base pan comprising a base wall and an internal wall, wherein the internal wall forms a first volume and a second volume at the base pan, the internal wall comprising a wall opening permitting fluid communication between the first volume and the second volume;
a mid-pan positioned on the base pan;
a base plate separating the mid-pan from the base pan, wherein a third volume is formed between the base plate and the mid-pan, and wherein the third volume is fluidly connected to the second volume;
a heater plate comprising a top surface at which foodstuffs are received for heating, the heater plate positioned on the mid-pan and forming a fourth volume between the mid-pan and the heater plate; and
a shaft extending from the mid-pan and through the base plate, wherein the shaft comprises a passage extending in fluid communication from the third volume to vertically above the heater plate, wherein the shaft comprises a shaft opening permitting fluid communication from the passage through the shaft to above the heater plate,
wherein the mid-pan comprises a pan opening permitting fluid communication between the third volume and the fourth volume.

19. The steam cooking appliance of claim 18, comprising:
a lid disposable onto the mid-pan or heater plate, wherein the lid encloses a fifth volume formed between the lid and the heater plate.

20. The steam cooking appliance of claim 18, wherein the base plate comprises a first base plate providing an upper barrier separating the first volume from the third volume, and wherein the base plate comprises a second base plate providing an upper barrier separating the second volume from the third volume.
